(19) United States
(12) Patent Application Publication
(10) Pub. No.: US 2025/0016828 A1
(43) Pub. Date: Jan. 9, 2025

(54) TWT OPERATION IN WIRELESS NETWORKS

(71) Applicant: Samsung Electronics Co., Ltd., Suwon-si (KR)

(72) Inventors: Rubayet Shafin, Allen, TX (US); Boon Loong Ng, Plano, TX (US); Peshal Nayak, Plano, TX (US); Vishnu Vardhan Ratnam, Plano, TX (US); Yue Qi, Plano, TX (US); Elliot Jen, Taipei (TW)

(21) Appl. No.: 18/750,138

(22) Filed: Jun. 21, 2024

Related U.S. Application Data
(60) Provisional application No. 63/524,803, filed on Jul. 3, 2023.
(60) Provisional application No. 63/525,894, filed on Jul. 10, 2023.
(60) Provisional application No. 63/538,257, filed on Sep. 13, 2023.

(51) Int. Cl. H04W 74/0816; H04W 74/08; H04W 84/12

(52) U.S. Cl. CPC H04W 74/0816; H04W 74/0866; H04W 84/12

(57) ABSTRACT

An access point (AP) affiliated with a non-simultaneous transmit and receive (NSTR) mobile AP multi-link device (MLD) and operating on a primary link may advertise a broadcast target wake time (TWT) schedule for the other AP affiliated with the same NSTR mobile AP MLD and operating on a nonprimary link by including a TWT element comprising a corresponding broadcast TWT parameter set field in the STA profile field of the Per-STA profile subelement of the basic multi-link element corresponding to the AP operating on the nonprimary link carried in beacon frames and/or probe response frame that it transmits on the primary link.

### CROSS-REFERENCE TO RELATED APPLICATIONS

This application claims the benefit of priority from U.S. Provisional Application No. 63/524,803, entitled “METHOD AND APPARATUS FOR TWT OPERATION WITH NSTR MOBILE AP MLD,” filed Jul. 3, 2023; U.S. Provisional Application No. 63/525,894, entitled “METHOD AND APPARATUS FOR TWT OPERATION WITH NSTR MOBILE AP MLD,” filed Jul. 10, 2023; and U.S. Provisional Application No. 63/538,257, entitled “METHOD AND APPARATUS FOR TWT OPERATION WITH NSTR MOBILE AP MLD,” filed Sep. 13, 2023, all of which are incorporated herein by reference in their entirety.

### TECHNICAL FIELD

This disclosure relates generally to a wireless communication system, and more particularly to, for example, but not limited to, a target wake time (TWT) operation in wireless communication systems.

### BACKGROUND

Wireless local area network (WLAN) technology has evolved toward increasing data rates and continues its growth in various markets such as home, enterprise and hotspots over the years since the late 1990s. WLAN allows devices to access the internet in the 2.4 GHZ, 5 GHZ, 6 GHz or 60 GHz frequency bands. WLANs are based on the Institute of Electrical and Electronic Engineers (IEEE) 802.11 standards. IEEE 802.11 family of standards aims to increase speed and reliability and to extend the operating range of wireless networks.

WLAN devices are increasingly required to support a variety of delay-sensitive applications or real-time applications such as augmented reality (AR), robotics, artificial intelligence (AI), cloud computing, and unmanned vehicles. To implement extremely low latency and extremely high throughput required by such applications, multi-link operation (MLO) has been suggested for the WLAN. The WLAN is formed within a limited area such as a home, school, apartment, or office building by WLAN devices. Each WLAN device may have one or more stations (STAs) such as the access point (AP) STA and the non-access-point (non-AP) STA.

The MLO may enable a non-AP multi-link device (MLD) to set up multiple links with an AP MLD. Each of multiple links may enable channel access and frame exchanges between the non-AP MLD and the AP MLD independently, which may reduce latency and increase throughput.

The description set forth in the background section should not be assumed to be prior art merely because it is set forth in the background section. The background section may describe aspects or embodiments of the present disclosure.

### SUMMARY

An aspect of the present disclosure provides an access point (AP) multi-link device (MLD) associated with a non-AP MLD in a wireless network. The AP MLD comprises at least two APs, each AP being affiliated with the AP MLD, and a processor coupled to the at least two Aps. The processor is configured to advertise, by a first AP affiliated with the AP MLD and operating on a primary link established between the first AP and a first STA affiliated with the non-AP MLD, a broadcast target wake time (TWT) schedule for a second AP affiliated with the AP MLD and operating on a non-primary link established between the second AP and a second STA affiliated with the non-AP MLD by including a TWT element comprising a broadcast TWT parameter set field corresponding to the second AP operating on the non-primary link in a broadcast frame via the primary link.

In some embodiments, the broadcast TWT parameter set field is included in a station (STA) profile field of a Per-STA profile subelement of a basic multi-link element.

In some embodiments, the broadcast frame is a beacon frame or a probe response frame.

In some embodiments, a value in a broadcast target wake time (TWT) persistence subfield corresponding to the broadcast TWT schedule is in reference to a most recent target beacon transmission time (TBTT) and beacon interval indicated by the first AP operating on the primary link.

In some embodiments, the AP MLD is a non-simultaneous transmit and receive (NSTR) mobile AP MLD.

In some embodiments, the processor is further configured to receive, by the second AP from the second STA, a TWT request to join the broadcast TWT schedule.

In some embodiments, the first AP is not in a multiple basic service set identifier (BSSID) set or the first AP corresponds to a transmitted BSSID in a multiple BSSID set.

In some embodiments, the primary link and the second link are a non-simultaneous transmit and receive (NSTR) link pair.

An aspect of the present disclosure provides an access point (AP) multi-link device (MLD) associated with a non-AP MLD in a wireless network. The AP MLD comprises at least two APs, each AP being affiliated with the AP MLD, and a processor coupled to the at least two Aps. The processor is configured to include, by a first AP affiliated with the AP MLD, a basic multi-link element for the AP MLD in a broadcast frame, wherein the basic multi-link element does not include a link information field unless the AP MLD is a non-simultaneous transmit and receive (NSTR) mobile AP MLD and the firs AP is operating on a primary link established between the first AP and a first STA affiliated with the non-AP MLD, and advertises a broadcast target wake time (TWT) schedule for a second AP affiliated with the AP MLD and operating on a non-primary link. The processor is configured to transmit, by the first AP affiliated with AP MLD, the broadcast frame.

In some embodiments, the first AP is not in a multiple basic service set identifier (BSSID) set or the first AP corresponds to a transmitted BSSID in a multiple BSSID set.

In some embodiments, the broadcast frame is a beacon frame or a probe response frame.

In some embodiments, the probe response frame is not in a multi-link probe response that the first AP transmits.

In some embodiments, when the first AP is affiliated with the NSTR mobile AP MLD and operating on the primary link and the first AP advertises the broadcast TWT schedule for the second AP, a station (STA) profile in the link formation field of the basic multi-link element only includes a broadcast TWT element for the second AP operating on the non-primary link.

An aspect of the present disclosure provides a non-access point (AP) multi-link device (MLD) associated with an AP MLD in a wireless network. The non-AP MLD comprises at least two STAs, each STA being affiliated with the non-AP MLD, and a processor coupled to the at least two STAs. The processor is configured to receive, by a first STA affiliated with the non-AP MLD and operating on a primary link established between the first STA and a first AP affiliated with the AP MLD, a broadcast frame via the primary link, the broadcast frame advertising a broadcast target wake time (TWT) schedule for a second AP affiliated with the AP MLD and operating on a non-primary link established between the second STA and an second AP affiliated with the AP MLD by including a TWT element comprising a broadcast TWT parameter set field corresponding to the second AP operating on the non-primary link. The processor is configured to transmit, by the second STA affiliated with the non-AP MLD and operating on the non-primary link, a TWT request to join the broadcast TWT schedule.

In some embodiments, the broadcast TWT parameter set field is included in a STA profile field of a Per-STA Profile subelement of a basic multi-link element.

In some embodiments, the broadcast frame is a beacon frame or a probe response frame.

In some embodiments, a value in a broadcast TWT persistence subfield corresponding to the broadcast TWT schedule is in reference to a most recent target beacon transmission time (TBTT) and beacon interval indicated by the first AP operating on the primary link.

In some embodiments, the AP MLD is a non-simultaneous transmit and receive (NSTR) mobile AP MLD.

In some embodiments, the first AP is not in a multiple basic service set identifier (BSSID) set or the first AP corresponds to a transmitted BSSID in a multiple BSSID set.

In some embodiments, the primary link and the second link are a non-simultaneous transmit and receive (NSTR) link pair.

### BRIEF DESCRIPTION OF THE DRAWINGS

FIG. 1 shows an example of a wireless network in accordance with an embodiment.

FIG. 2A shows an example of AP in accordance with an embodiment.

FIG. 2B shows an example of STA in accordance with an embodiment.

FIG. 3 shows an example of multi-link communication operation in accordance with an embodiment.

FIG. 4 shows an example NSTR operation in accordance with an embodiment.

FIG. 5 shows an example process for advertising a broadcast TWT schedule for an NSTR mobile AP MLD in accordance with an embodiment.

FIG. 6 shows an example process for advertising a broadcast TWT schedule for an NSTR mobile AP MLD in accordance with an embodiment.

FIG. 7 shows an example format of a TWT element in accordance with an embodiment.

FIG. 8 shows an example format of the multi-link element in accordance with an embodiment.

FIG. 9 shows an example process for advertising a broadcast TWT schedule for an NSTR mobile AP MLD using an aligned schedule in accordance with an embodiment.

FIG. 10 shows an example process for advertising a broadcast TWT schedule in accordance with an embodiment.

FIG. 11 shows an example of an aligned schedule in accordance with an embodiment.

FIG. 12 shows an example of establishing a broadcast TWT in accordance with an embodiment.

FIG. 13 shows an example process for advertising a broadcast TWT schedule in accordance with an embodiment.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below, in connection with the appended drawings, is intended as a description of various implementations and is not intended to represent the only implementations in which the subject technology may be practiced. Rather, the detailed description includes specific details for the purpose of providing a thorough understanding of the inventive subject matter. As those skilled in the art would realize, the described implementations may be modified in various ways, all without departing from the scope of the present disclosure. Accordingly, the drawings and description are to be regarded as illustrative in nature and not restrictive. Like reference numerals designate like elements.

The following description is directed to certain implementations for the purpose of describing the innovative aspects of this disclosure. However, a person having ordinary skill in the art will readily recognize that the teachings herein can be applied in a multitude of different ways. The examples in this disclosure are based on WLAN communication according to the Institute of Electrical and Electronics Engineers (IEEE) 802.11 standard, including IEEE 802.11be standard and any future amendments to the IEEE 802.11 standard. However, the described embodiments may be implemented in any device, system or network that is capable of transmitting and receiving radio frequency (RF) signals according to the IEEE 802.11 standard, the Bluetooth standard, Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), 5G NR (New Radio), AMPS, or other known signals that are used to communicate within a wireless, cellular or internet of things (IoT) network, such as a system utilizing 3G, 4G, 5G, 6G, or further implementations thereof, technology.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

Multi-link operation (MLO) is a key feature that is currently being developed by the standards body for next generation extremely high throughput (EHT) Wi-Fi systems in IEEE 802.11be. The Wi-Fi devices that support MLO are referred to as multi-link devices (MLD). With MLO, it is possible for a non-AP MLD to discover, authenticate, associate, and set up multiple links with an AP MLD. Channel access and frame exchange is possible on each link between the AP MLD and non-AP MLD.

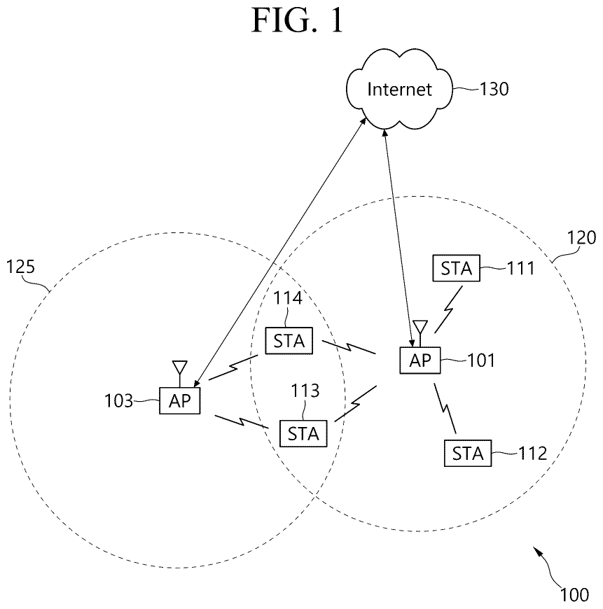

FIG. 1 shows an example of a wireless network 100 in accordance with an embodiment. The embodiment of the wireless network 100 shown in FIG. 1 is for illustrative purposes only. Other embodiments of the wireless network 100 could be used without departing from the scope of this disclosure.

As shown in FIG. 1, the wireless network 100 may include a plurality of wireless communication devices. Each wireless communication device may include one or more stations (STAs). The STA may be a logical entity that is a singly addressable instance of a medium access control (MAC) layer and a physical (PHY) layer interface to the wireless medium. The STA may be classified into an access point (AP) STA and a non-access point (non-AP) STA. The AP STA may be an entity that provides access to the distribution system service via the wireless medium for associated STAs. The non-AP STA may be a STA that is not contained within an AP-STA. For the sake of simplicity of description, an AP STA may be referred to as an AP and a non-AP STA may be referred to as a STA. In the example of FIG. 1, APs 101 and 103 are wireless communication devices, each of which may include one or more AP STAs. In such embodiments, APs 101 and 103 may be AP multi-link device (MLD). Similarly, STAs 111-114 are wireless communication devices, each of which may include one or more non-AP STAs. In such embodiments, STAs 111-114 may be non-AP MLD.

The APs 101 and 103 communicate with at least one network 130, such as the Internet, a proprietary Internet Protocol (IP) network, or other data network. The AP 101 provides wireless access to the network 130 for a plurality of stations (STAs) 111-114 with a coverage are 120 of the AP 101. The APs 101 and 103 may communicate with each other and with the STAs using Wi-Fi or other WLAN communication techniques.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

In FIG. 1, dotted lines show the approximate extents of the coverage area 120 and 125 of APs 101 and 103, which are shown as approximately circular for the purposes of illustration and explanation. It should be clearly understood that coverage areas associated with APs, such as the coverage areas 120 and 125, may have other shapes, including irregular shapes, depending on the configuration of the APs.

As described in more detail below, one or more of the APs may include circuitry and/or programming for management of MU-MIMO and OFDMA channel sounding in WLANs. Although FIG. 1 shows one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101 and 103 could communicate directly with the network 130 and provides STAs with direct wireless broadband access to the network 130. Further, the APs 101 and/or 103 could provide access to other or additional external networks, such as external telephone networks or other types of data networks.

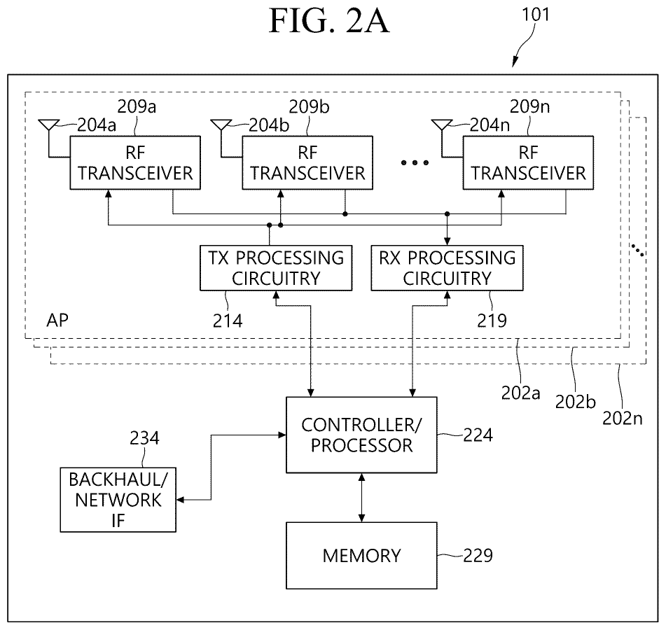

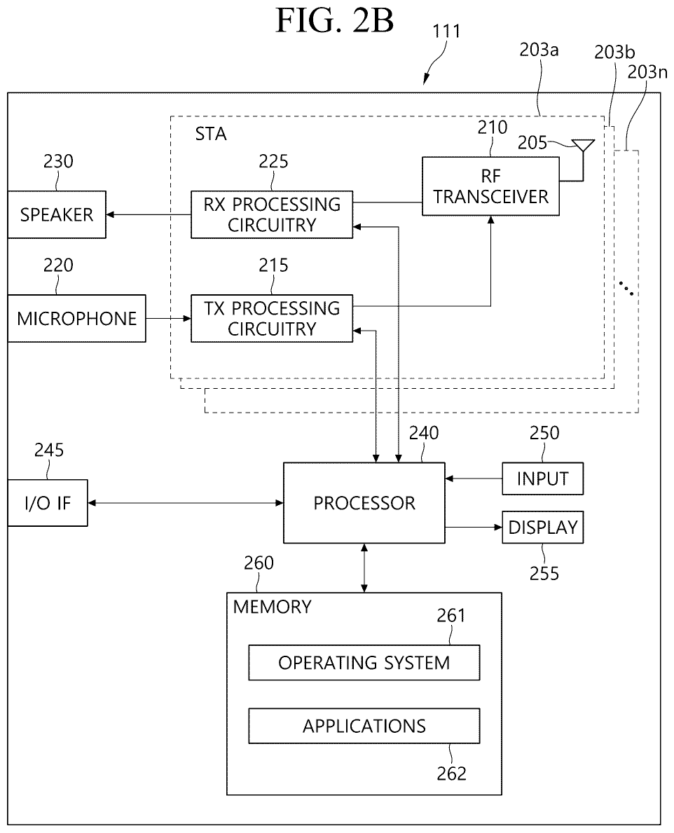

FIG. 2A shows an example of AP 101 in accordance with an embodiment. The embodiment of the AP 101 shown in FIG. 2A is for illustrative purposes, and the AP 103 of FIG. 1 could have the same or similar configuration. However, APs come in a wide range of configurations, and FIG. 2A does not limit the scope of this disclosure to any particular implementation of an AP.

As shown in FIG. 2A, the AP 101 may include multiple antennas 204a-204n, multiple radio frequency (RF) transceivers 209a-209n, transmit (TX) processing circuitry 214, and receive (RX) processing circuitry 219. The AP 101 also may include a controller/processor 224, a memory 229, and a backhaul or network interface 234. The RF transceivers 209a-209n receive, from the antennas 204a-204n, incoming RF signals, such as signals transmitted by STAs in the network 100. The RF transceivers 209a-209n down-convert the incoming RF signals to generate intermediate (IF) or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

The TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-converts the baseband or IF signals to RF signals that are transmitted via the antennas 204a-204n.

The controller/processor 224 can include one or more processors or other processing devices that control the overall operation of the AP 101. For example, the controller/processor 224 could control the reception of uplink signals and the transmission of downlink signals by the RF transceivers 209a-209n, the RX processing circuitry 219, and the TX processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP 101 by the controller/processor 224 including a combination of DL MU-MIMO and OFDMA in the same transmit opportunity. In some embodiments, the controller/processor 224 may include at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP 101 to communicate with other devices or systems over a backhaul connection or over a network. The interface 234 could support communications over any suitable wired or wireless connection(s). For example, the interface 234 could allow the AP 101 to communicate over a wired or wireless local area network or over a wired or wireless connection to a larger network (such as the Internet). The interface 234 may include any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP 101 may include circuitry and/or programming for management of channel sounding procedures in WLANs. Although FIG. 2A illustrates one example of AP 101, various changes may be made to FIG. 2A. For example, the AP 101 could include any number of each component shown in FIG. 2A. As a particular example, an AP could include a number of interfaces 234, and the controller/processor 224 could support routing functions to route data between different network addresses. As another example, while shown as including a single instance of TX processing circuitry 214 and a single instance of RX processing circuitry 219, the AP 101 could include multiple instances of each (such as one per RF transceiver). Alternatively, only one antenna and RF transceiver path may be included, such as in legacy APs. Also, various components in FIG. 2A could be combined, further subdivided, or omitted and additional components could be added according to particular needs.

As shown in FIG. 2A, in some embodiment, the AP 101 may be an AP MLD that includes multiple APs 202a-202n. Each AP 202a-202n is affiliated with the AP MLD 101 and includes multiple antennas 204a-204n, multiple radio frequency (RF) transceivers 209a-209n, transmit (TX) processing circuitry 214, and receive (RX) processing circuitry 219. Each APs 202a-202n may independently communicate with the controller/processor 224 and other components of the AP MLD 101. FIG. 2A shows that each AP 202a-202n has separate multiple antennas, but each AP 202a-202n can share multiple antennas 204a-204n without needing separate multiple antennas. Each AP 202a-202n may represent a physical (PHY) layer and a lower media access control (MAC) layer.

FIG. 2B shows an example of STA 111 in accordance with an embodiment. The embodiment of the STA 111 shown in FIG. 2B is for illustrative purposes, and the STAs 111-114 of FIG. 1 could have the same or similar configuration. However, STAs come in a wide variety of configurations, and FIG. 2B does not limit the scope of this disclosure to any particular implementation of a STA.

As shown in FIG. 2B, the STA 111 may include antenna(s) 205, a RF transceiver 210, TX processing circuitry 215, a microphone 220, and RX processing circuitry 225. The STA 111 also may include a speaker 230, a controller/processor 240, an input/output (I/O) interface (IF) 245, a touchscreen 250, a display 255, and a memory 260. The memory 260 may include an operating system (OS) 261 and one or more applications 262.

The RF transceiver 210 receives, from the antenna(s) 205, an incoming RF signal transmitted by an AP of the network 100. The RF transceiver 210 down-converts the incoming RF signal to generate an IF or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the controller/processor 240 for further processing (such as for web browsing data).

The TX processing circuitry 215 receives analog or digital voice data from the microphone 220 or other outgoing baseband data (such as web data, e-mail, or interactive video game data) from the controller/processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205.

The controller/processor 240 can include one or more processors and execute the basic OS program 261 stored in the memory 260 in order to control the overall operation of the STA 111. In one such operation, the controller/processor 240 controls the reception of downlink signals and the transmission of uplink signals by the RF transceiver 210, the RX processing circuitry 225, and the TX processing circuitry 215 in accordance with well-known principles. The controller/processor 240 can also include processing circuitry configured to provide management of channel sounding procedures in WLANs. In some embodiments, the controller/processor 240 may include at least one microprocessor or microcontroller.

The controller/processor 240 is also capable of executing other processes and programs resident in the memory 260, such as operations for management of channel sounding procedures in WLANs. The controller/processor 240 can move data into or out of the memory 260 as required by an executing process. In some embodiments, the controller/processor 240 is configured to execute a plurality of applications 262, such as applications for channel sounding, including feedback computation based on a received null data packet announcement (NDPA) and null data packet (NDP) and transmitting the beamforming feedback report in response to a trigger frame (TF). The controller/processor 240 can operate the plurality of applications 262 based on the OS program 261 or in response to a signal received from an AP. The controller/processor 240 is also coupled to the I/O interface 245, which provides STA 111 with the ability to connect to other devices such as laptop computers and handheld computers. The I/O interface 245 is the communication path between these accessories and the main controller/processor 240.

The controller/processor 240 is also coupled to the input 250 (such as touchscreen) and the display 255. The operator of the STA 111 can use the input 250 to enter data into the STA 111. The display 255 may be a liquid crystal display, light emitting diode display, or other display capable of rendering text and/or at least limited graphics, such as from web sites. The memory 260 is coupled to the controller/processor 240. Part of the memory 260 could include a random access memory (RAM), and another part of the memory 260 could include a Flash memory or other read-only memory (ROM).

Although FIG. 2B shows one example of STA 111, various changes may be made to FIG. 2B. For example, various components in FIG. 2B could be combined, further subdivided, or omitted and additional components could be added according to particular needs. In particular examples, the STA 111 may include any number of antenna(s) 205 for MIMO communication with an AP 101. In another example, the STA 111 may not include voice communication or the controller/processor 240 could be divided into multiple processors, such as one or more central processing units (CPUs) and one or more graphics processing units (GPUs). Also, while FIG. 2B illustrates the STA 111 configured as a mobile telephone or smartphone, STAs could be configured to operate as other types of mobile or stationary devices.

As shown in FIG. 2B, in some embodiment, the STA 111 may be a non-AP MLD that includes multiple STAs 203a-203n. Each STA 203a-203n is affiliated with the non-AP MLD 111 and includes an antenna(s) 205, a RF transceiver 210, TX processing circuitry 215, and RX processing circuitry 225. Each STAs 203a-203n may independently communicate with the controller/processor 240 and other components of the non-AP MLD 111. FIG. 2B shows that each STA 203a-203n has a separate antenna, but each STA 203a-203n can share the antenna 205 without needing separate antennas. Each STA 203a-203n may represent a physical (PHY) layer and a lower media access control (MAC) layer.

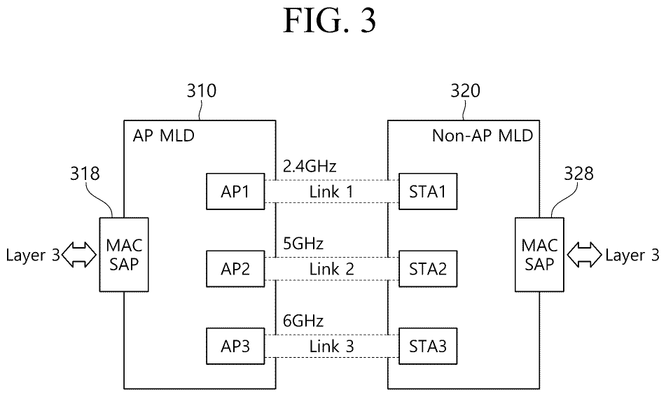

FIG. 3 shows an example of multi-link communication operation in accordance with an embodiment. The multi-link communication operation may be usable in IEEE 802.11be standard and any future amendments to IEEE 802.11 standard. In FIG. 3, an AP MLD 310 may be the wireless communication device 101 and 103 in FIG. 1 and a non-AP MLD 220 may be one of the wireless communication devices 111-114 in FIG. 1.

As shown in FIG. 3, the AP MLD 310 may include a plurality of affiliated APs, for example, including AP 1, AP 2, and AP 3. Each affiliated AP may include a PHY interface to wireless medium (Link 1, Link 2, or Link 3). The AP MLD 310 may include a single MAC service access point (SAP) 318 through which the affiliated APs of the AP MLD 310 communicate with a higher layer (Layer 3 or network layer). Each affiliated AP of the AP MLD 310 may have a MAC address (lower MAC address) different from any other affiliated APs of the AP MLD 310. The AP MLD 310 may have a MLD MAC address (upper MAC address) and the affiliated APs share the single MAC SAP 318 to Layer 3. Thus, the affiliated APs share a single IP address, and Layer 3 recognizes the AP MLD 310 by assigning the single IP address.

The non-AP MLD 320 may include a plurality of affiliated STAs, for example, including STA 1, STA 2, and STA 3. Each affiliated STA may include a PHY interface to the wireless medium (Link 1, Link 2, or Link 3). The non-AP MLD 320 may include a single MAC SAP 328 through which the affiliated STAs of the non-AP MLD 320 communicate with a higher layer (Layer 3 or network layer). Each affiliated STA of the non-AP MLD 320 may have a MAC address (lower MAC address) different from any other affiliated STAs of the non-AP MLD 320. The non-AP MLD 320 may have a MLD MAC address (upper MAC address) and the affiliated STAs share the single MAC SAP 328 to Layer 3. Thus, the affiliated STAs share a single IP address, and Layer 3 recognizes the non-AP MLD 320 by assigning the single IP address.

The AP MLD 310 and the non-AP MLD 320 may set up multiple links between their affiliate APs and STAs. In this example, the AP 1 and the STA 1 may set up Link 1 which operates in 2.4 GHz band. Similarly, the AP 2 and the STA 2 may set up Link 2 which operates in 5 GHZ band, and the AP 3 and the STA 3 may set up Link 3 which operates in 6 GHz band. Each link may enable channel access and frame exchange between the AP MLD 310 and the non-AP MLD 320 independently, which may increase date throughput and reduce latency. Upon associating with an AP MLD on a set of links (setup links), each non-AP device is assigned a unique association identifier (AID).

The following documents are hereby incorporated by reference in their entirety into the present disclosure as if fully set forth herein: i) IEEE 802.11-2020, “Wireless LAN Medium Access Control (MAC) and Physical Layer (PHY) Specifications” and ii) IEEE P802.11be/D3.0, “Wireless LAN Medium Access Control (MAC) and Physical Layer (PHY) Specifications.”

Target wake time (TWT) operation is a feature of power management in WLAN networks. The TWT operation has been introduced in IEEE 802.11ah standard and later modified in IEEE 802.11ax standard. The TWT operation enables an AP to manage activity in the basic service set (BSS) to minimize contention between STAs and reduce the required wake times for STAs during the TWT operation. It can be achieved by allocating STAs to operate at non-overlapping times or frequencies and perform the frame exchange sequences in pre-scheduled service periods. In the TWT operation, a STA can wake up at pre-scheduled times that have been negotiated with an AP or another STA in the BSS. The STA does not need to be aware of TWT parameter values of other STAs within the BSS or of STAs in other BSSs. The STA does not need to be aware that a TWT service period (SP) is used to exchange frames with other STAs. Frames transmitted during a TWT SP can employ any PPDU (physical layer protocol data unit) format supported by the pair of STAs that have established the corresponding TWT agreement or TWT schedule, including, but not limited to, HE MU (high efficiency multi-user) PPDU, HE TB (high efficiency trigger based) PPDU.

IEEE 802.11 standard describes two types of TWT operations: individual TWT operation and broadcast TWT operation. In the individual TWT operation, an individual TWT agreement can be established between two STAs or between a STA and an AP. The negotiation for the individual TWT operation may occur between two STAs or between a STA and an AP on an individual basis. An AP may have TWT agreements with multiple STAs. Any changes in the TWT agreement between the AP and one STA do not affect the TWT agreement between the AP and other STAs.

On the other hand, the broadcast TWT operates in a membership-based approach. In broadcast TWT operation, an AP can set up a shared TWT session for a group of STAs. The AP is typically the controller of the broadcast TWT schedule. The non-AP STAs in the BSS can request membership in the broadcast TWT schedule, or the AP can send unsolicited response to a STA to make the STA a member of the broadcast TWT schedule that the AP maintains in the BSS. The AP may advertise and maintain multiple broadcast TWT schedules in the BSS. When a change is made to any broadcast TWT schedules in the BSS, it may affect all or some of STAs that are members of the corresponding broadcast TWT schedule.

An AP MLD is typically able to simultaneously transmit and receive frames over all of its links. However, the current version of IEEE 802.11be standard defines a special type of AP MLD, referred to as a ‘non-simultaneous transmit and receive (NSTR) mobile AP MLD,’ which is a mobile AP MLD having an NSTR link pair. In this disclosure, a mobile AP refers to AP that is capable of keeping its basic service set (BSS) operational while its location is changed. Two kinds of links are defined for the NSRT mobile AP MLD: primary link and non-primary link. A beacon frame or a probe response frame can only be sent over the primary link and cannot be sent over the non-primary link. Moreover, when transmitting a PPDU over the non-primary link, an AP affiliated with the NSTR mobile AP MLD that is operating on the non-primary link, or a non-AP STA affiliated with a non-AP MLD that is associated with the NSTR mobile AP MLD and operating on the non-primary link, needs to align the PPDU with a PPDU transmitted over the primary link.

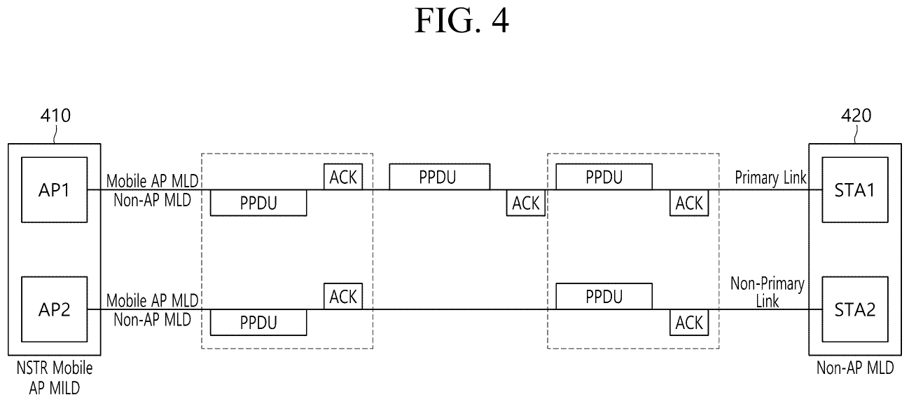

FIG. 4 shows an example NSTR operation in accordance with an embodiment. The operation depicted in FIG. 4 is for illustration purposes and does not limit the scope of this disclosure to any particular implementations.

In FIG. 4, an AP MLD 410 includes affiliated AP 1 and AP 2, and a non-AP MLD 420 includes affiliated STA 1 and STA 2. In this example of FIG. 4, the AP MLD 410 is an NSTR mobile AP MLD. An NSTR link pair is established between the AP MLD 410 and the non-AP MLD 420. Specifically, a primary link is established between AP 1 and STA 1, while a non-primary link is established between AP 2 and STA 2. The AP MLD 410 and the non-AP MLD 420 exchanges PPDUs in both primary link and non-primary link. However, PPDUs transmitted on the non-primary link from AP 2 and STA 2 are aligned with PPDUs transmitted in the primary link.

According to the current WLAN system, a broadcast TWT schedule can be advertised by a TWT scheduling AP by including a corresponding TWT element in a beacon frame or a probe response frame that the TWT scheduling AP transmits. However, an AP affiliated with an NSTR mobile AP MLD and operating on the non-primary link does not transmit a beacon frame or a probe response frame. Therefore, in the current WLAN system, there is no mechanism to advertise a broadcast TWT schedule for the non-primary link of the NSTR mobile AP MLD.

This disclosure provides various example procedures for broadcast TWT operation with an NSTR mobile AP MLD.

In some embodiments, an AP affiliated with an NSTR mobile AP MLD and operating on a non-primary link may advertise a broadcast TWT schedule for the non-primary link by carrying an TWT element, comprising a corresponding broadcast TWT schedule, in a beacon frame and/or a probe response frame transmitted on a primary link. It is because there is no beaconing on the non-primary link of the NSTR mobile AP MLD. Therefore, the advertisement for the broadcast TWT schedule for the non-primary link can be made through the AP operating on the primary link at the NSTR mobile AP MLD.

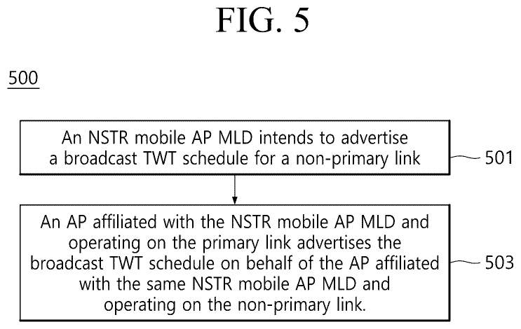

FIG. 5 shows an example process for advertising a broadcast TWT schedule for an NSTR mobile AP MLD in accordance with an embodiment. For explanatory and illustration purposes, the example process 500 may be performed by AP 1 and AP 2 depicted in FIG. 4. Although one or more operations are described or shown in particular sequential order, in other embodiments the operations may be rearranged in a different order, which may include performance of multiple operations in at least partially overlapping time periods.

Referring to FIGS. 4 and 5, the process 500 may begin in operation 501. In operation 501, an NSTR mobile MLD (e.g., AP MLD 410 in FIG. 4) intends to advertise a broadcast TWT schedule for a non-primary link.

In operation 503, an AP affiliated with the NSTR mobile AP MLD and operating on the primary link (e.g., AP 1 in FIG. 4) advertises the broadcast TWT schedule on the primary link on behalf of the AP affiliated with the same NSTR mobile AM MLD and operating on the non-primary link (e.g., AP 2 in FIG. 4).

In some embodiments, a broadcast TWT schedule for a non-primary link can be advertised by including a corresponding TWT element in a Per-STA profile subelement transmitted on a primary link. Specifically, an AP affiliated with an NSTR mobile AP MLD and operating on a primary link may advertise a broadcast TWT schedule for an AP affiliated with the same NSTR mobile MLD and operating on a non-primary link. This can be achieved by including a TWT element comprising a corresponding broadcast TWT parameter set field in a STA profile field of a Per-STA profile subelement of a basic multi-link element. The corresponding broadcast TWT parameter set field corresponds to the AP operating on the non-primary link and is carried in a beacon frame and/or a probe response frame transmitted on the primary link. The value in the broadcast TWT persistence subfield corresponding to the broadcast TWT schedule may be in reference to the most recent target beacon transmission time (TBTT) and beacon interval (BI) indicated by the AP operating on the primary link.

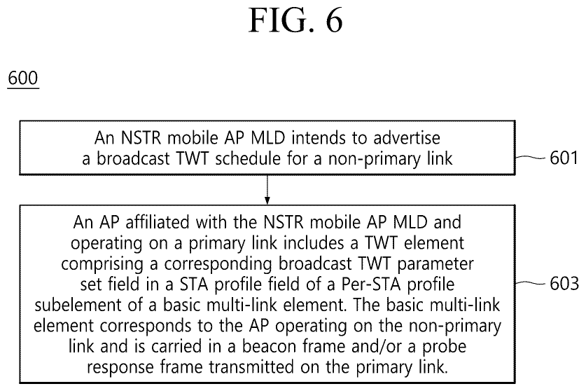

FIG. 6 shows an example process for advertising a broadcast TWT schedule for an NSTR mobile AP MLD in accordance with an embodiment. For explanatory and illustration purposes, the example process 600 may be performed by AP 1 and AP 2 depicted in FIG. 4. Although one or more operations are described or shown in particular sequential order, in other embodiments the operations may be rearranged in a different order, which may include performance of multiple operations in at least partially overlapping time periods. The process in FIG. 6 illustrates an example to advertise a broadcast TWT schedule for a non-primary link by including a corresponding TWT element in a Per-STA profile subelement transmitted on a primary link.

Referring to FIGS. 4 and 6, the process 600 may begin in operation 601. In operation 601, an NSTR mobile MLD (e.g., AP MLD 410 in FIG. 4) intends to advertise a broadcast TWT schedule for a non-primary link.

In operation 603, an AP affiliated with an NSTR mobile AP MLD and operating on a primary link (e.g., AP 1 in FIG. 4) may advertise a broadcast TWT schedule for an AP affiliated with the same NSTR mobile MLD and operating on a non-primary link (e.g., AP 2 in FIG. 4). This can be achieved by including a TWT element comprising a corresponding broadcast TWT parameter set field in a STA profile field of a Per-STA profile subelement within a link information (link info) field of a basic multi-link element. The corresponding broadcast TWT parameter set field corresponds to the AP operating on the non-primary link and is carried in a beacon frame and/or a probe response frame transmitted on the primary link.

In some embodiments, if an AP affiliated with an NSTR mobile AP MLD and operating on a primary link advertises a broadcast TWT schedule for an AP affiliated with the same NSTR mobile MLD and operating on a non-primary link. This can be achieved by including a TWT element, comprising a corresponding broadcast TWT parameter set field in a Per-STA profile field of a Per-STA Profile subelement of a basic multi-link element. The basic multi-link element corresponds to the AP operating on the non-primary link and is carried in a beacon frame or a probe response frame on the primary link. In this scenario, a timing field, such as a target wake time field, in the TWT element may be in reference to a TSF of the primary link. In another embodiment, the timing field in the TWT element may be in reference to the TSF of the non-primary link.

In some embodiments, an AP affiliated with an NSTR mobile AP MLD and operating on a primary link advertises a TWT schedule on the primary link that is an aligned schedule. Since the NSTR mobile AP MLD can have a maximum of two links (e.g., primary link and non-primary link), the advertisement of the aligned schedule on the primary link may mean that the TWT schedule is also available on the non-primary link.

In some embodiments, if an AP affiliated with an NSTR mobile AP MLD and operating on a primary link intends to advertise a broadcast TWT schedule for an AP affiliated with the same NSTR mobile AP MLD and operating on a non-primary link, the AP operating on the primary link may advertise the broadcast TWT schedule on the primary link and indicate that the broadcast TWT schedule is an aligned schedule, for example, by setting an Aligned subfield of a Request Type filed in a corresponding broadcast TWT parameter set field to 1. Since an NSTR mobile AP MLD can have a maximum of two links (primary link and non-primary link), a non-AP MLD associated with the NSTR mobile AP MLD that receives the advertisement of the aligned schedule, through a beacon frame or a probe response frame on the primary link, can uniquely identify the presence of the aligned TWT schedule on the non-primary link.

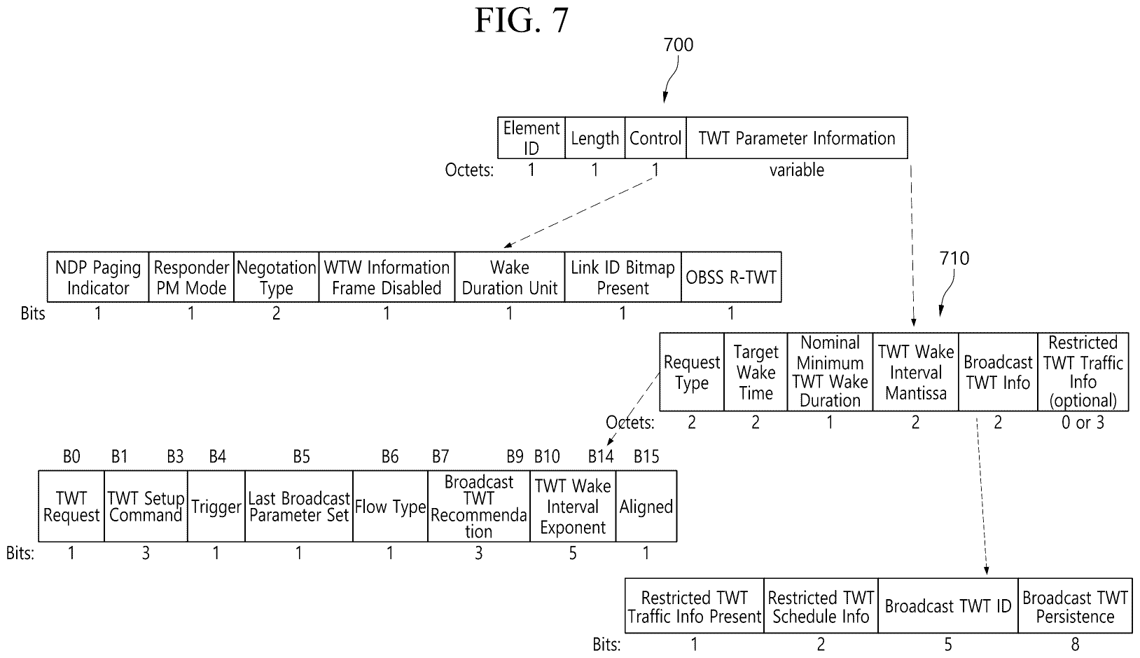

FIG. 7 shows an example format of the TWT element in accordance with an embodiment.

In FIG. 7, the TWT element 700 may include an Element identifier (ID) field, a length field, a Control field, and a TWT Parameter Information field. The Element ID field may include information to identify the TWT element 700. The Length field may indicate a length of the TWT element 700.

The Control field may include a null data PPDU (physical layer protocol data unit) (NDP) Paging Indicator subfield, a Responder power management (PM) Mode subfield, a Negotiation Type subfield, a TWT Information Frame Disabled subfield, a Wake Duration Unit subfield, a Link 1D Bitmap Present subfield, and an OBSS R-TWT subfield. The NDP Paging Indicator subfield may indicate whether an NDP paging field is present or not in an Individual TWT Parameter Set field. The Responder PM Mode subfield may indicate the power management mode, such as active mode and power save (PS) mode. The negotiation Type subfield may indicate whether the information included in the TWT element is for the negotiation of parameters of broadcast or individual TWT or Wake TBTT (target beacon transmission time) interval. The MSB (most significant bit) of the Negotiation Type subfield is the Broadcast field which indicates if one or more Broadcast TWT Parameter Sets are contained in the TWT element. The TWT Information Frame Disabled subfield may indicate whether the reception of TWT information frame is disabled by the STA. The Wake Duration Unit subfield may indicate the unit of the Nominal Minimum TWT Wake Duration subfield in the Broadcast TWT Parameter Set field. The Link 1D Bitmap Present subfield may indicate the presence of the Link 1D Bitmap field in the Individual TWT Parameter Set field. The OBSS R-TWT subfield may indicate whether the R-TWT schedules corresponding to the Broadcast TWT Parameter Set fields in the TWT element are the R-TWT schedule of the neighboring BSS. When the OBSS R-TWT subfield is set to ‘1’, it may indicate that the R-TWT schedules in the TWT element are the R-TWT schedule of the neighboring BSS. Otherwise, it indicates that there is no neighboring BSS's R-TWT schedule in the TWT element.

The TWT Parameter information field includes an individual TWT parameter set field or one or more Broadcast TWT Parameter Set fields. For the convenience of description, FIG. 7 illustrates the Broadcast TWT Parameter Set fields. The Broadcast TWT Parameter Set field 710 may include a Request Type field, a Target Wake Time field, a Nominal Minimum TWT Wake Duration field, a TWT Wake Interval Mantissa field, a Broadcast TWT Info field, and an optional Restricted TWT traffic Info field.

The Request Type field of the Broadcast TWT Parameter Set field 710 can be used to indicate the presence of the aligned TWT schedule. Referring to FIG. 7, the Request Type field includes a TWT Request subfield, a TWT Setup Command subfield, a Trigger subfield, a Last Broadcast Parameter Set subfield, a Flow Type subfield, a Broadcast TWT Recommendation subfield, a TWT Wake Interval Exponent subfield, and an Aligned subfield. The Request Type field may be usable for Broadcast TWT operation.

The TWT Request subfield may indicate if the transmitting STA is a TWT scheduling AP (or STA) or a TWT scheduled STA (or AP). The TWT Setup Command subfield may indicate the type of TWT command, such as Request TWT, Suggest TWT, Demand TWT, TWT Grouping, Accept TWT, Alternate TWT, Dictate TWT and Reject TWT. The Trigger subfield may indicate whether the TWT SP indicated by the TWT element includes triggering frames. The Last Broadcast Parameter Set subfield may indicate whether another Broadcast TWT Parameter Set field follows this Broadcast TWT Parameter Set field. The Flow Type subfield may indicate the type of interaction, for example, an announced TWT or an unannounced TWT between the TWT scheduled STA and the TWT scheduling AP at TWT. The Broadcast TWT Recommendation subfield may indicate recommendations on the types of frames that are transmitted by TWT scheduled STAs and TWT scheduling AP during the broadcast TWT SP. For instance, the types of frames may be PS-Poll and QoS Null frames, management frames, control response frames, or No constraints on the frame. The TWT Wake Interval Exponent subfield may indicate the value of the exponent of the TWT wake interval value. The Aligned subfield may indicate whether one or more of other links of the AP MLD have broadcast TWT schedules that are aligned with the corresponding schedule. More specifically, if the subfield is set to 1, it may indicate that there are one or more schedules on other links that are aligned with the TWT schedule identified by the Broadcast TWT Parameter Set field. Otherwise, the schedule is no such schedule on the other links. As discussed above, in some embodiments, if an AP affiliated with an NSTR mobile AP MLD and operating on a primary link intends to advertise a broadcast TWT schedule for an AP affiliated with the same NSTR mobile AP MLD and operating on a non-primary link, the AP operating on the primary link may advertise the broadcast TWT schedule on the primary link and indicate that the broadcast TWT schedule is an aligned schedule, for example, by setting an Aligned subfield of a Request Type filed in a corresponding broadcast TWT parameter set field to 1.

The Target Wake Time field may include an unsigned integer corresponding to a TSF (time synchronization function) time for the TWT scheduled STA to wake up. The Target Wake Time field may indicate the start time of the TWT service period (SP) on the corresponding link. The Nominal Minimum TWT Wake Duration field may indicate the minimum amount of time that the TWT scheduled STA is expected to be awake in order to complete the frame exchanges for the period of TWT wake interval. The TWT wake interval is the average time that the TWT scheduled STA expects to elapse between successive TWT SPs. The TWT Wake Interval Mantissa field may indicate the value of the mantissa of the TWT wake interval value. The Broadcast TWT Info field may include information related to the broadcast TWT, such as a restricted TWT traffic info present field, a restricted TWT schedule info field, a Broadcast TWT ID field and a Broadcast TWT Persistence field. The restricted TWT traffic info present field indicates whether the restricted TWT traffic info field is present. The restricted TWT schedule info field indicates whether an active R-TWT schedule is active. The Broadcast TWT ID field indicates a specific broadcast TWT for which the transmitting STA is providing TWT parameters. The Broadcast TWT persistence field indicates the number of TBTTs during which the Broadcast TWT SPs corresponding to this broadcast TWT parameter set are present.

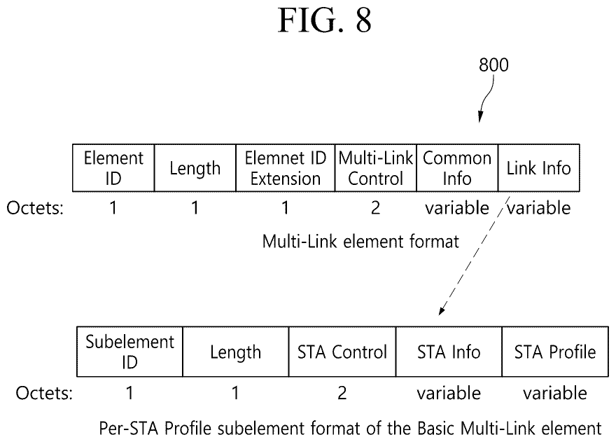

FIG. 8 shows an example format of the multi-link element in accordance with an embodiment.

In FIG. 8, the Multi-Link element 800 includes an Element identifier ID field, a length field, an Element ID Extension field, a Multi-Link Control field, a Common Info field, and a Link Info field. The Element ID field and the Element ID Extension field may include information to identify the Multi-Link element 800. The Length field may indicate a length of the TWT element 800. The Multi-Link Control field may include a type field indicating a type of the Multi-Link element 800. In some implementations, a value of the type field indicates that the Multi-Link element 800 is a Basic Multi-Link element. The Common Info field may include information that is common to all the links with some exceptions.

The Link Info field may include information specific to one or more links and be optionally present. The Link Info field may include one or more Per-STA Profile subelements. FIG. 8 shows an example Per-STA Profile subelement included in the Link Info field of a Basic Multi-Link element. The Per-STA Profile subelement may include a Subelement ID field, a Length field, a STA Control field, a STA Info field, and a STA Profile field. The Subelement ID field may include information to identify the Per-STA Profile subelement. The Length field may indicate a length of the Per-STA Profile subelement. The STA Control field may include control information for the Basic Multi-Link element. The STA Profile field may include various information. In some embodiments, an AP affiliated with an NSTR mobile AP MLD and operating on a primary link may advertise a broadcast TWT schedule for an AP affiliated with the same NSTR mobile MLD and operating on a non-primary link. This can be achieved by including a TWT element comprising a corresponding broadcast TWT parameter set field in a STA profile field of a Per-STA profile subelement within the Link Info field of the basic multi-link element. The broadcast TWT parameter set field corresponds to the other AP operating on the non-primary link and is carried in a beacon frame and/or a probe response frame transmitted on the primary link.

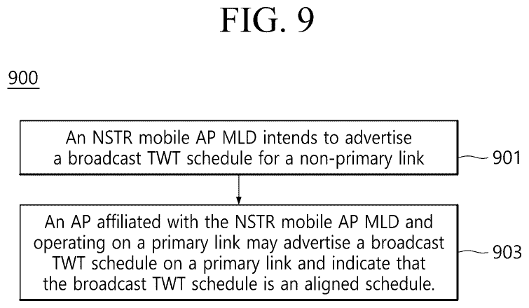

FIG. 9 shows an example process for advertising a broadcast TWT schedule for an NSTR mobile AP MLD using an aligned schedule in accordance with an embodiment. For explanatory and illustration purposes, the example process 900 may be performed by AP 1 and AP 2 depicted in FIG. 4. Although one or more operations are described or shown in particular sequential order, in other embodiments the operations may be rearranged in a different order, which may include performance of multiple operations in at least partially overlapping time periods.

Referring to FIGS. 4 and 9, the process 900 may begin in operation 901. In operation 901, an NSTR mobile MLD (e.g., AP MLD 410 in FIG. 4) intends to advertise a broadcast TWT schedule for a non-primary link.

In operation 903, an AP affiliated with the NSTR mobile AP MLD and operating on the primary link (e.g., AP 1 in FIG. 4) advertises the broadcast TWT schedule on the primary link and indicates that the broadcast TWT schedule is an aligned schedule.

In some embodiments, a STA is affiliated with a non-AP MLD associated with an NSTR mobile MLD and is operating on a non-primary link. When the STA sends a TWT request to an AP affiliated with the NSTR mobile MLD and operating on the non-primary link or the STA requests a membership for an aligned schedule on the non-primary link, the STA may use the same broadcast TWT ID that is used to identify the aligned schedule advertised on a primary link.

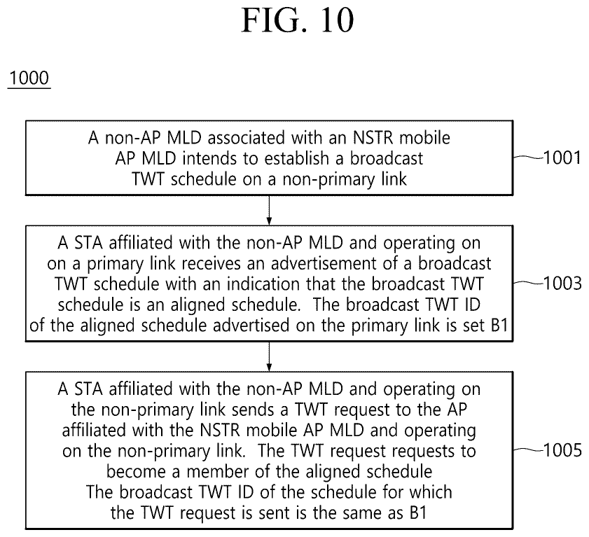

FIG. 10 shows an example process for advertising a broadcast TWT schedule in accordance with an embodiment. For explanatory and illustration purposes, the example process 1000 may be performed by STA 1 and STA 2 depicted in FIG. 4. Although one or more operations are described or shown in particular sequential order, in other embodiments the operations may be rearranged in a different order, which may include performance of multiple operations in at least partially overlapping time periods. The process in FIG. 10 illustrates an example of the usage of an aligned schedule for advertising a broadcast TWT schedule for a non-primary link of an NSTR Mobile AP MLD.

Referring to FIGS. 4 and 10, the process 1000 may begin in operation 1001. In operation 1001, a non-AP MLD (e.g., non-AP MLD 420 in FIG. 4) is associated with an NSTR mobile AP MLD (e.g., AP MLD 410 in FIG. 4). The non-AP MLD intends to establish a broadcast TWT schedule on a non-primary link.

In operation 1003, a STA affiliated with the non-AP MLD and operating on a primary link (e.g., STA 1 in FIG. 4) receives an advertisement of a broadcast TWT schedule via the primary link. In some embodiments, the advertisement may include an indication that the broadcast TWT schedule is an aligned schedule. The broadcast TWT ID of the aligned schedule advertised on the primary link may be set as B1, for example.

In operation 1005, a STA affiliated with the non-AP MLD and operating on the non-primary link (e.g., STA 2 in FIG. 4) sends a TWT request to the AP affiliated with the NSTR mobile AP MLD and operating on the non-primary link (e.g., AP 2 in FIG. 4) via the non-primary link. The TWT request requests to become a member of the aligned schedule. The broadcast TWT ID of the broadcast TWT schedule for which the request is sent may be the same as B1.

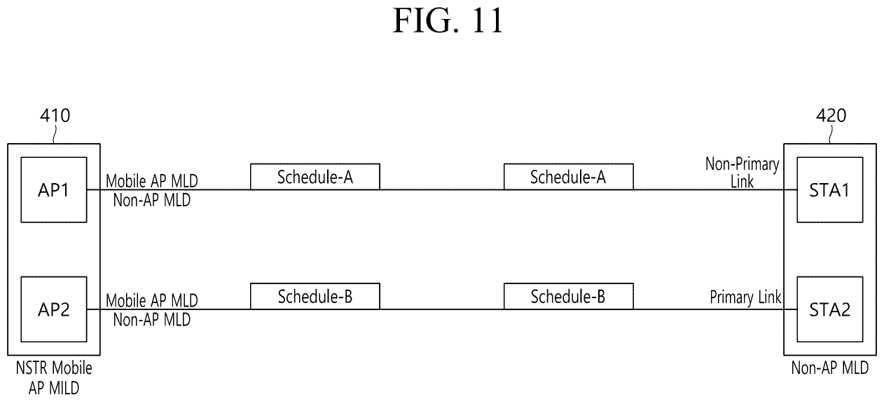

FIG. 11 shows an example of an aligned schedule in accordance with an embodiment. The operation depicted in FIG. 11 is for illustration purposes and does not limit the scope of this disclosure to any particular implementations.

Referring to FIG. 11, an NSTR link pair including primary link and non-primary link is established between the AP MLD 410 and the non-AP MLD 420. The AP MLD 410 is an NSTR mobile AP MLD. Unlike FIG. 4, the non-primary link is established between AP 1 and STA 1, while the primary link is established between AP 2 and STA 2. As shown, a broadcast TWT schedule A (“Schedule-A”) is established on the non-primary link between AP 1 and STA1, while a broadcast TWT schedule B (“Schedule-B) is established on the primary link between AP 2 and STA 1. Schedule-A and Schedule-B are aligned with each other. In FIG. 11, Schedule-A and Schedule-B may have the same TWT parameters including the broadcast TWT ID, as explained with reference to FIG. 10.

In some embodiments, an NSTR mobile AP MLD can advertise or establish a first broadcast TWT schedule for a non-primary link via a primary link if a primary link has a second broadcast TWT schedule such that the start time and the end time of the TWT SP corresponding to the first broadcast TWT schedule on the non-primary link overlaps in time with the TWT SP corresponding to the second TWT schedule on the primary link.

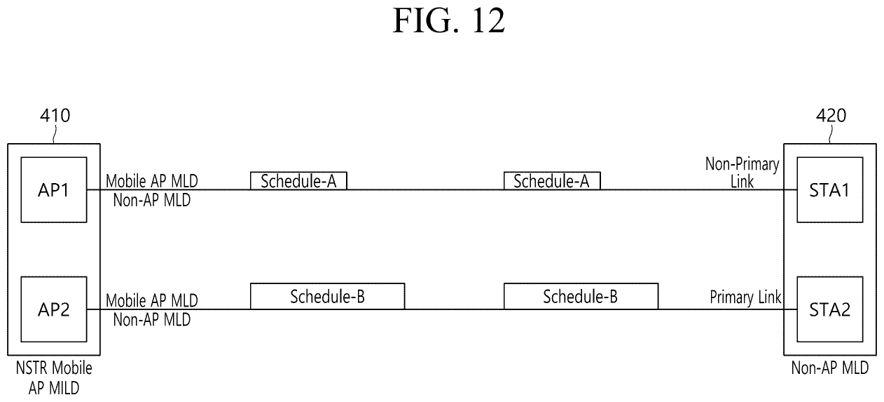

FIG. 12 shows an example of establishing a broadcast TWT in accordance with an embodiment. The operation depicted in FIG. 12 is for illustration purposes and does not limit the scope of this disclosure to any particular implementations.

The example of FIG. 12 is similar to the example of FIG. 11, except for the TWT SP duration. Referring to FIG. 12, Schedule-A and Schedule-B are aligned in the start time of the TWT SP, while the TWT SP duration of Schedule-B is longer than the TWT SP duration of Schedule-A. The start time and the end time of the TWT SP of Schedule-A overlaps in time with the TWT SP of Schedule-B. In the scenario, the AP MLD 410 can advertise or establish Schedule-A for the non-primary link via the primary link.

In some embodiments, an AP affiliated with an NSTR mobile AP MLD intends to advertise a broadcast TWT schedule for a non-primary link by including a corresponding a TWT element comprising a corresponding broadcast TWT parameter set field in a beacon frame or a probe response frame transmitted on a primary link. The AP may include a link info field in a basic multi-link element for an AP affiliated with the NSTR mobile AP MLD and operating on the non-primary link.

In some embodiments, an AP affiliated with an NSTR mobile AP MLD and operating on a primary link may advertise a broadcast TWT schedule for the other AP affiliated with the same NSTR mobile AP MLD and operating on a non-primary link by including a TWT element comprising a corresponding broadcast TWT parameter set field in the STA Profile field of the Per-STA Profile subelement of the basic multi-link element corresponding to the AP operating on the nonprimary link carried in the beacon frames and probe response frames that it transmits on the primary link. The value in the broadcast TWT persistence subfield corresponding to the broadcast TWT schedule shall be in reference to the most recent TBTT and Beacon Interval indicated by the AP operating on the primary link.

In some embodiments, if an AP affiliated with an AP MLD is not in a multiple BSSID set or the AP corresponds to a transmitted BSSID in a multiple BSSID set, then the AP, in a beacon frame and/or a probe Response frame that is not a multi-link probe response that it transmits, may selectively include or not include the link Info field of the basic multi-link element for the AP MLD. In some implementations, the AP may not include the link Info field of the basic multi-link element for the AP MLD unless the AP is affiliated with an NSTR mobile AP MLD and operating on the primary link, and advertises a broadcast TWT schedule for the other AP affiliated with the same NSTR mobile AP MLD and operating on the nonprimary link, in which case the link Info field only includes a broadcast TWT element for that AP operating on the nonprimary channel. In some implementations, the AP may include the link Info field of the basic multi-link element for the AP MLD if the AP is affiliated with the NSTR mobile AP MLD and operating on the primary link, and advertises a broadcast TWT schedule for the other AP affiliated with the same NSTR mobile AP MLD and operating on the primary. In this case, the link Info field only includes a broadcast TWT element for the AP operating on the non-primary link.

In some embodiments, a broadcast TWT schedule advertised for the AP affiliated with an NSTR mobile AP MLD and operating on the nonprimary link is aligned with the broadcast TWT schedule advertised for the other AP affiliated with the same NSTR mobile AP MLD and operating on the primary link.

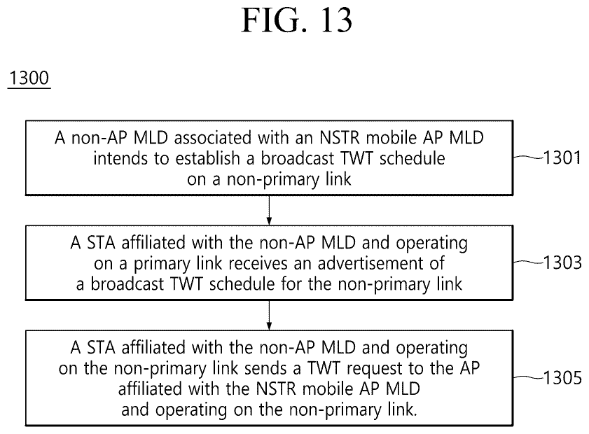

FIG. 13 shows an example process for advertising a broadcast TWT schedule in accordance with an embodiment. For explanatory and illustration purposes, the example process 1300 may be performed by STA 1 and STA 2 depicted in FIG. 4. Although one or more operations are described or shown in particular sequential order, in other embodiments the operations may be rearranged in a different order, which may include performance of multiple operations in at least partially overlapping time periods. The process in FIG. 13 illustrates a general operation of a non-AP MLD to establish a broadcast TWT schedule for a non-primary link of an NSTR Mobile AP MLD.

Referring to FIGS. 4 and 13, the process 1300 may begin in operation 1301. In operation 1301, a non-AP MLD (e.g., non-AP MLD 420 in FIG. 4) is associated with an NSTR mobile AP MLD (e.g., AP MLD 410 in FIG. 4). The non-AP MLD intends to establish a broadcast TWT schedule on a non-primary link.

In operation 1303, a STA affiliated with the non-AP MLD and operating on a primary link (e.g., STA 1 in FIG. 4) receives an advertisement of a broadcast TWT schedule via the primary link. In some embodiments, a TWT element comprising a corresponding broadcast TWT parameter set field is included in a STA profile field of a Per-STA profile subelement within a link information (link info) field of a basic multi-link element. The basic multi-link element corresponds to the AP operating on the non-primary link and is carried in a beacon frame and/or a probe response frame transmitted on the primary link.

In operation 1305, a STA affiliated with the non-AP MLD and operating on the non-primary link (e.g., STA 2 in FIG. 4) sends a TWT request to the AP affiliated with the NSTR mobile AP MLD and operating on the non-primary link (e.g., AP 2 in FIG. 4) via the non-primary link. The TWT request may request to become a member of the broadcast TWT schedule.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the invention. The word exemplary is used to mean serving as an example or illustration. To the extent that the term “include,” “have,” or the like is used, such term is intended to be inclusive in a manner similar to the term “comprise” as “comprise” is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of”′ preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously or may be performed as a part of one or more other steps, operations, or processes. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using a phrase means for or, in the case of a method claim, the element is recited using the phrase step for.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. An access point (AP) multi-link device (MLD) associated with a non-AP MLD in a wireless network, the AP MLD comprising:
at least two APs, each AP being affiliated with the AP MLD; and
a processor coupled to the at least two APs, the processor configured to:
advertise, by a first AP affiliated with the AP MLD and operating on a primary link established between the first AP and a first STA affiliated with the non-AP MLD, a broadcast target wake time (TWT) schedule for a second AP affiliated with the AP MLD and operating on a non-primary link established between the second AP and a second STA affiliated with the non-AP MLD by including a TWT element comprising a broadcast TWT parameter set field corresponding to the second AP operating on the non-primary link in a broadcast frame via the primary link.

2. The AP MLD of claim 1, wherein the broadcast TWT parameter set field is included in a station (STA) profile field of a Per-STA profile subelement of a basic multi-link element.

3. The AP MLD of claim 1, wherein the broadcast frame is a beacon frame or a probe response frame.

4. The AP MLD of claim 1, wherein a value in a broadcast target wake time (TWT) persistence subfield corresponding to the broadcast TWT schedule is in reference to a most recent target beacon transmission time (TBTT) and beacon interval indicated by the first AP operating on the primary link.

5. The AP MLD of claim 1, wherein the AP MLD is a non-simultaneous transmit and receive (NSTR) mobile AP MLD.

6. The AP MLD of claim 1, wherein the processor is further configured to receive, by the second AP from the second STA, a TWT request to join the broadcast TWT schedule.

7. The AP MLD of claim 1, wherein the first AP is not in a multiple basic service set identifier (BSSID) set or the first AP corresponds to a transmitted BSSID in a multiple BSSID set.

8. The AP MLD of claim 1, wherein the primary link and the second link are a non-simultaneous transmit and receive (NSTR) link pair.

9. An access point (AP) multi-link device (MLD) associated with a non-AP MLD in a wireless network, the AP MLD comprising:
at least two APs, each AP being affiliated with the AP MLD; and
a processor coupled to the at least two APs, the processor configured to:
include, by a first AP affiliated with the AP MLD, a basic multi-link element for the AP MLD in a broadcast frame, wherein the basic multi-link element does not include a link information field unless the AP MLD is a non-simultaneous transmit and receive (NSTR) mobile AP MLD and the firs AP is operating on a primary link established between the first AP and a first STA affiliated with the non-AP MLD, and advertises a broadcast target wake time (TWT) schedule for a second AP affiliated with the AP MLD and operating on a non-primary link; and
transmit, by the first AP affiliated with AP MLD, the broadcast frame.

10. The AP MLD of claim 9, wherein the first AP is not in a multiple basic service set identifier (BSSID) set or the first AP corresponds to a transmitted BSSID in a multiple BSSID set.

11. The AP MLD of claim 9, wherein the broadcast frame is a beacon frame or a probe response frame.

12. The AP MLD of claim 11, wherein the probe response frame is not in a multi-link probe response that the first AP transmits.

13. The AP MLD of claim 9, wherein when the first AP is affiliated with the NSTR mobile AP MLD and operating on the primary link and the first AP advertises the broadcast TWT schedule for the second AP, a station (STA) profile in the link formation field of the basic multi-link element only includes a broadcast TWT element for the second AP operating on the non-primary link.

14. A non-access point (AP) multi-link device (MLD) associated with an AP MLD in a wireless network, the non-AP MLD comprising:
at least two STAs, each STA being affiliated with the non-AP MLD; and
a processor coupled to the at least two STAs, the processor configured to:
receive, by a first STA affiliated with the non-AP MLD and operating on a primary link established between the first STA and a first AP affiliated with the AP MLD, a broadcast frame via the primary link, the broadcast frame advertising a broadcast target wake time (TWT) schedule for a second AP affiliated with the AP MLD and operating on a non-primary link established between the second STA and an second AP affiliated with the AP MLD by including a TWT element comprising a broadcast TWT parameter set field corresponding to the second AP operating on the non-primary link; and
transmit, by the second STA affiliated with the non-AP MLD and operating on the non-primary link, a TWT request to join the broadcast TWT schedule.

15. The non-AP MLD of claim 14, wherein the broadcast TWT parameter set field is included in a STA profile field of a Per-STA Profile subelement of a basic multi-link element.

16. The non-AP MLD of claim 14, wherein the broadcast frame is a beacon frame or a probe response frame.

17. The non-AP MLD of claim 14, wherein a value in a broadcast TWT persistence subfield corresponding to the broadcast TWT schedule is in reference to a most recent target beacon transmission time (TBTT) and beacon interval indicated by the first AP operating on the primary link.

18. The non-AP MLD of claim 14, wherein the AP MLD is a non-simultaneous transmit and receive (NSTR) mobile AP MLD.

19. The non-AP MLD of claim 14, wherein the first AP is not in a multiple basic service set identifier (BSSID) set or the first AP corresponds to a transmitted BSSID in a multiple BSSID set.

20. The non-AP MLD of claim 14, wherein the primary link and the second link are a non-simultaneous transmit and receive (NSTR) link pair.
